(19) United States
(12) Patent Application Publication
(10) Pub. No.: US 2009/0191940 A1
(43) Pub. Date: Jul. 30, 2009

(54) SLOT MACHINE AND CONTROL METHOD THEREOF

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Koto-ku (JP)

(21) Appl. No.: 12/061,901

(22) Filed: Apr. 3, 2008

Related U.S. Application Data
(60) Provisional application No. 61/024,365, filed on Jan. 29, 2008.

(51) Int. Cl. G06F 17/00

(52) U.S. Cl. 463/20

(57) ABSTRACT

In a slot game executed by a slot machine, three reels are scrolled and then stopped, and an image for an effect is displayed on an image display area. Then an award is provided according to a symbol combination displayed when the reels have been stopped and the image displayed on the image display area. Therefore, more number of winning combinations can be assignable than the number of symbol combinations assignable by symbols drawn on the three reels.

### CROSS-REFERENCE TO RELATED APPLICATION

This application is based upon and claims the benefit of U.S. Provisional Patent Application Ser. No. 61/024,365, filed on Jan. 29, 2008; the entire contents of which are incorporated herein by reference for all purposes.

### BACKGROUND OF THE INVENTION

1. Field of the Invention

The present invention relates to a slot machine for playing games using medals, coins, bills and soon, and a control method thereof.

2. Description of Related Art

Each slot machine disclosed in the U.S. Pat. No. 7,309,282 and the U.S. Pat. No. 7,311,602 B2 is known as a relevant slot machine. In a conventional slot machine, plural reels starts spinning and then stops sequentially after a player has inserted a medal(s), a coin(s) or a bill(s) into an insertion slot and has pressed a start switch.

A reel band on which symbols are drawn is provided on each circumferential surface of the reels. Symbols are displayed in a display area(s) provided on a front of a cabinet after the reels has come to a stops. An award will be provided when a symbol combination has brought a specific combination.

In the conventional slot machine like this, since the length of a reel band is limited, the number of symbols capable of being drawn on one reel is also limited. Therefore, diversification of symbol combinations or minute dissimilation of payout amounts cannot be expressed. Consequently, expression of more winning combinations by symbols displayed in a display area(s) and an easily-understandable image effect(s) is desired in order for more players to play.

### SUMMARY OF THE INVENTION

A first aspect of the present invention provides a slot machine that includes: plural reels each of which is rotatable and has symbols on its circumferential surface; a display which (a) is provided in front of the reels, and (b) has a image display area including a symbol display area for displaying the symbols of each of the reels, [(c) the image display area can be set in a transmissive state or in a image-displaying state for displaying an image]; and a controller operable to execute a slot game. In the slot game, the reels are spun and then stopped after a bet has been received, and then an award is provided or a transition to a bonus game is executed when the symbols in the symbol display area and the image displayed in the image display area have achieve a specific combination.

A second aspect of the present invention provides a slot machine that includes: plural reels each of which is rotatable and has symbols on its circumferential surface; a display which (a) is provided in front of the reels, and (b) has a image display area including a symbol display area for displaying the symbols of each of the reels, [(c) the image display area can be set in a transmissive state or in a image-displaying state for displaying an image]; and a controller operable to execute a slot game. In the slot game, (A) the reels are spun and then stopped after a bet has been received, (B) produce a primary effect in which a specific image moves within the image display area when at least one of the symbols in the symbol display area has been a specific symbol or when the symbols in the symbol display area have achieved a specific symbol combination, and (C) an award is provided or a transition to a bonus game is executed after a predetermined effect with the specific image has been produced in a final stage of the primary effect.

A third aspect of the present invention provides a control method of a slot machine that includes: spinning, by a controller, plural reels each of which has symbols on its circumferential surface, displaying, by the controller, an image on a display with the reels spinning (the display is provided in front of the reels and having an image display area including a symbol display area for displaying the symbols of the reels), stopping, by the controller, the spinning reels, and providing, by the controller, an award or executing a transition to a bonus game when the symbols of the reels displayed in the symbol display area and the image displayed in the image display area have achieve a specific combination.

### BRIEF DESCRIPTION OF THE DRAWINGS

FIG. 1A is an image screen example in a first embodiment of the present invention;

FIG. 1B is an image screen example in the first embodiment of the present invention;

FIG. 1C is an image screen example in the first embodiment of the present invention;

FIG. 1D is an image screen example in the first embodiment of the present invention;

FIG. 2 is a perspective view of the slot machine in embodiments of the present invention;

FIG. 3 is a block diagram showing a circuit configuration of the slot machine in the embodiments of the present invention;

FIG. 4 is a perspective view of a display panel used in the slot machine in the embodiments of the present invention;

FIG. 5 is an exploded perspective view of the display panel used in the slot machine in the embodiments of the present invention;

FIG. 6 is a payout table used in the slot machine of the first embodiment of the present invention;

FIG. 7 is a flowchart showing a processing procedure of slot game execution processing executed by the slot machine in the first embodiment of the present invention;

FIG. 8 is a flowchart showing a processing procedure of reel controlling processing executed by the slot machine in the first embodiment of the present invention;

FIG. 9 is a flowchart showing a processing procedure of image effect controlling processing executed by the slot machine in the first embodiment of the present invention;

FIG. 10A is an image screen example in the first embodiment of the present invention;

FIG. 10B is an image screen example in the first embodiment of the present invention;

FIG. 10C is an image screen example in the first embodiment of the present invention;

FIG. 10D is an image screen example in the first embodiment of the present invention;

FIG. 11A is an image screen example in the first embodiment of the present invention;

FIG. 11B is an image screen example in the first embodiment of the present invention;

FIG. 11C is an image screen example in the first embodiment of the present invention;

FIG. 11D is an image screen example in the first embodiment of the present invention;

FIG. 12A is an image screen example in the first embodiment of the present invention;

FIG. 12B is an image screen example in the first embodiment of the present invention;

FIG. 12C is an image screen example in the first embodiment of the present invention;

FIG. 12D is an image screen example in the first embodiment of the present invention;

FIG. 13 is a flowchart showing a processing procedure of image effect controlling processing executed by the slot machine in a second embodiment of the present invention;

FIG. 14 is a flowchart showing a processing procedure of bonus game execution processing executed by the slot machine in a second embodiment of the present invention;

FIG. 15 is a payout table used by the slot machine of the second embodiment of the present invention;

FIG. 16 is a flowchart showing a processing procedure of slot game execution processing executed by the slot machine in a third embodiment of the present invention.

FIG. 17 is a flowchart showing a processing procedure of reel controlling processing executed by the slot machine in the third embodiment of the present invention;

FIG. 18 is a flowchart showing a processing procedure of image effect controlling processing executed by the slot machine in the third embodiment of the present invention; and

FIG. 19 is a payout table used by the slot machine of the second embodiment of the present invention.

### DETAILED DESCRIPTION OF THE EMBODIMENT

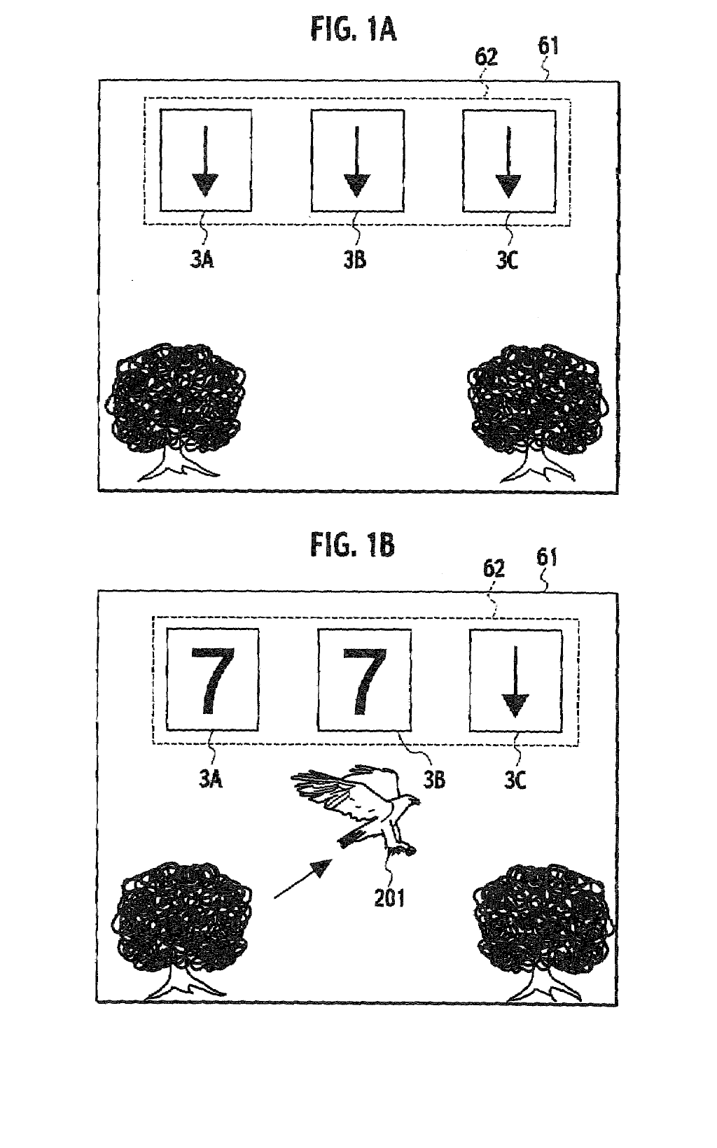

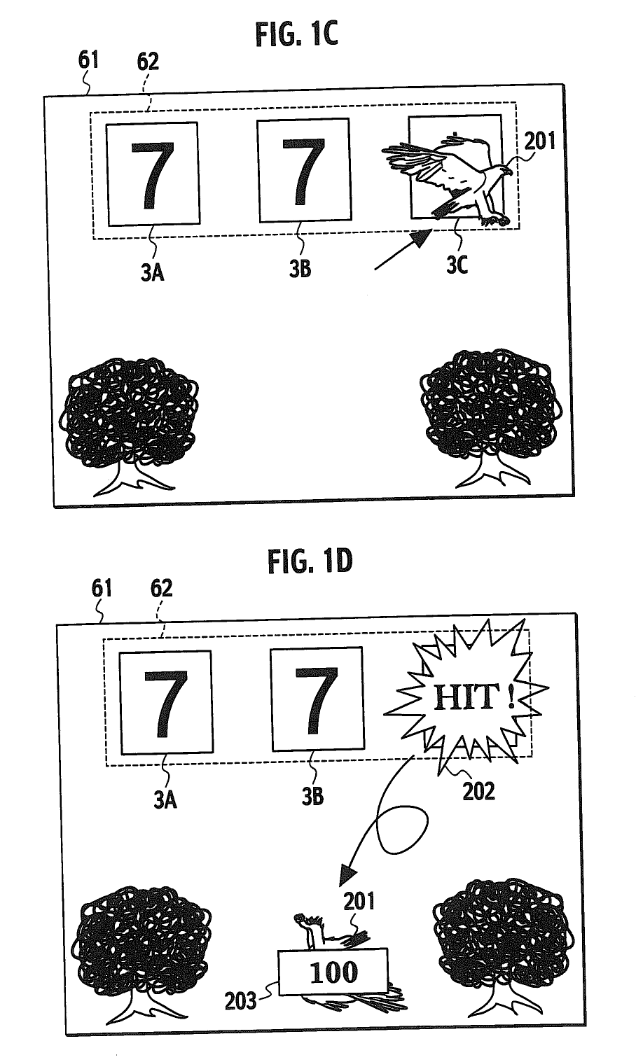

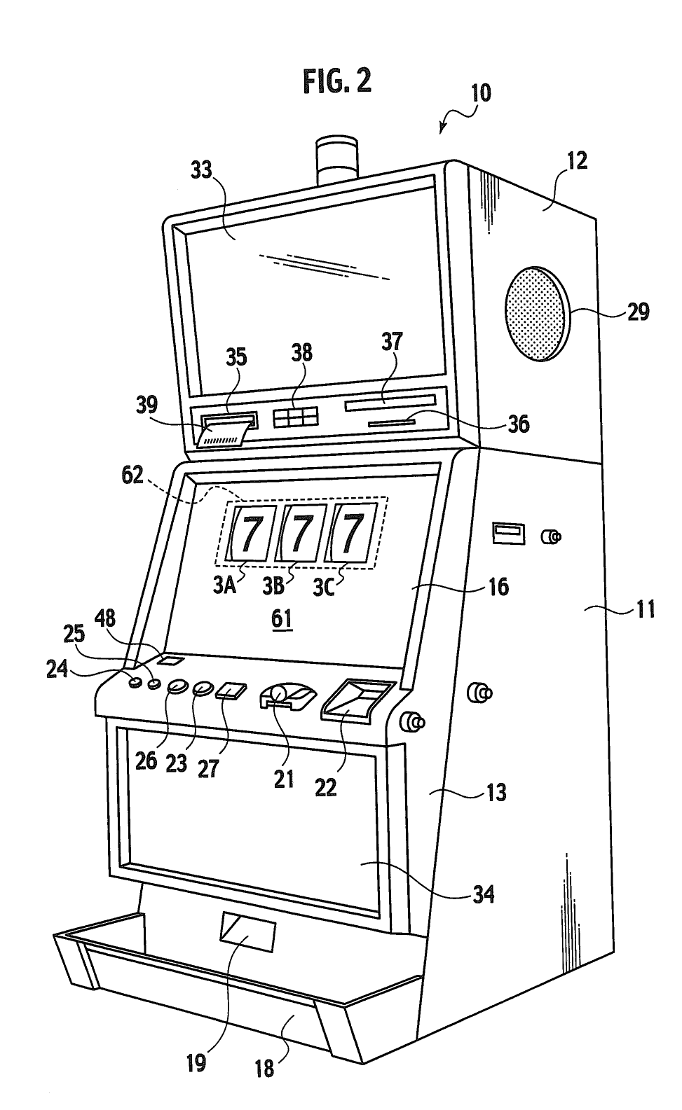

Hereinafter, features of embodiments according to the present invention will be explained with reference to screen image examples shown in FIGS. 1A, 1B, 1C and 1D and a perspective view of a slot machine 10 shown in FIG. 2. FIGS. 1A to 1D show the screen image examples displayed on a display 16 of the slot machine 10 in one embodiment of the present invention.

The display 16 shown in the same figure is configured by a transmissive liquid crystal panel. An image display area 61 on the display is set in one of a transmissive state and an image-displaying state as mentioned later. The inside behind the display 16 can be seen when the image display area 61 is in the transmissive state. Various effect images can be displayed on the image display area when the image display area is in the image-displaying state. In this case, the inside behind the display 16 cannot be seen.

In addition, a spinning reel device 3 including three reels 3A, 3B and 3C is provided behind the display 16. A reel band is attached onto each circumferential surface of the reels 3A, 3B and 3C. Symbols are drawn on each of the reel band. A symbol display area 62, which is an area in front of the reels 3A, 3B and 3C, within the image display area 61 is set in the transmissive state. The image display area 61 excluding the symbol display area 62 is set in the image-displaying state. Therefore, a player can see the reels 3A, 3B and 3C through the symbol display area 62 set in the transmissive state.

FIGS. 1A, 1B, 1C and 1D show spinning/stopped states of the reels 3A, 3B and 3C and a transition of the effect images displayed on the image display area 61.

As shown in FIG. 1A, the reels 3A, 3B and 3C of the spinning reel device 3 start to spin after a game has been started. “Tree” images are displayed at each of both right and left lower areas in the image display area 61 at this time. Then, the reels 3A, 3B and 3C come to stops in the order “3A”, “3B” and then As shown in FIG. 1A, a winning combination will be achieved in case where a “7” symbol is displayed at each of the both reels 3A and 3B with the two reels 3A and 3B stopped (in other words, when “7” symbols can be seen through the symbol display area 62) and further a “7” symbol is displayed with the last reel 3C stopped. In this case, an “eagle” image 201 is displayed at the lower area in the image display area 61 and then gradually moves toward the front of the reel 3C on the symbol display area 62 as shown in FIG. 1B.

When the “eagle” image 201 has reached the front of the reel 3C on the symbol display area 62 as shown in FIG. 1C, the spinning reel 3C comes to a stop and a “HIT” image 202 is displayed in front of the reel 3C on the symbol display area 62 as shown in FIG. 1D. After that, the “eagle” image 201 drops and a “100” image 203 indicating the number of medals to be awarded is displayed at the drop position. In other words, an award corresponding to one hundred medals is provided when a symbol combination “7-7-HIT” has been achieved.

In this manner, according to a slot machine and a control method of a slot machine of the present invention, since it is determined whether or not an award is to be provided according to symbols displayed through the symbol display area 62 with the reels 3A, 3B and 3C stopped and an effect image displayed on the image display area 61, an entertainment feature can be improved.

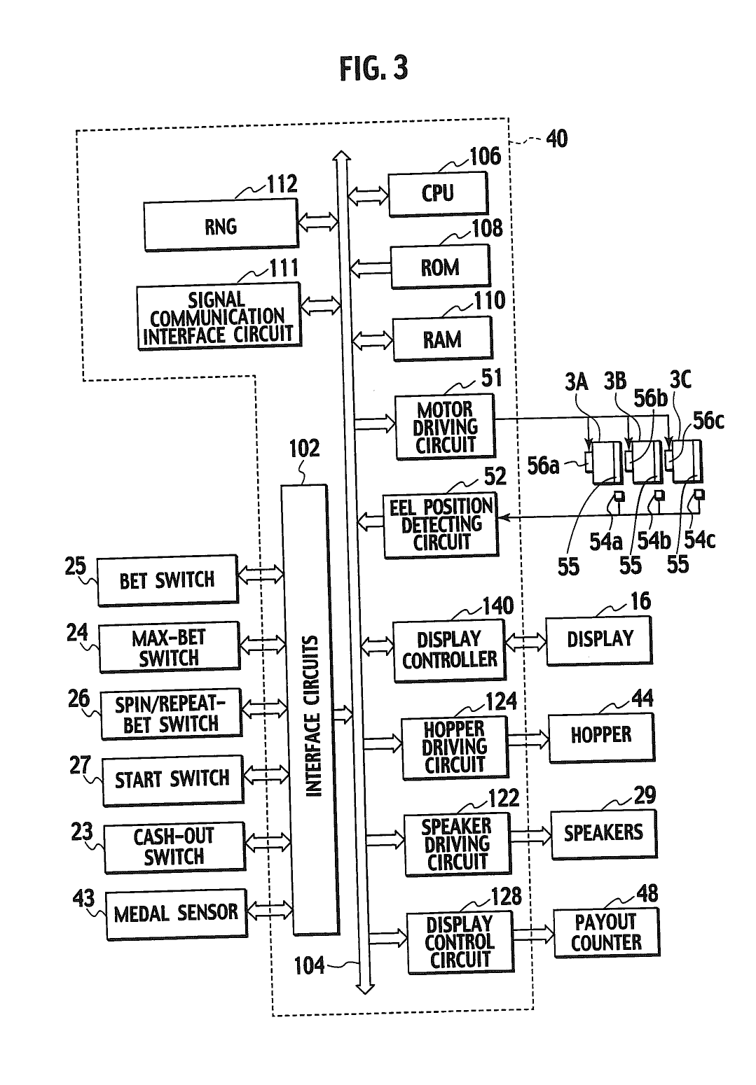

FIG. 2 is a perspective view of the slot machine of embodiments of the present invention. The slot machine 10 includes a cabinet 11, atop box 12 provided on top of the cabinet 11 and a main door 13. The cabinet 11a has a lower display 16 disposed on its plane facing the player. Various component devices are disposed within the cabinet 11, such as a controller 40 (see FIG. 3) for electrically controlling the slot machine 10 and a hopper 44 (see FIG. 3) for controlling an insertion, pooling, and a cash-out of medals.

The main door 13 is attached to the cabinet 11 so that it can be opened and closed. The display 16 is disposed on an upper portion of the main door 13. In addition, the spinning-reel device 3 including three reels 3A, 3B and 3C capable of spinning is provided behind the display 16.

As will be described in detail later, the display 16 is configured with the transmissive liquid crystal panel having the image display area 61. The image display area 61 can set in any one state among the transmissive state, in which visible through the display 16, or the image-displaying state, in which various images can be displayed thereon, by an execution of an after-mentioned control.

For example, a player can see various symbols displayed by the spinning reel device 3 through the symbol display area with the symbol display area 62 in the transmissive state, which is a partial area of the image display area 61 in front of the spinning reel device 3 provided behind the display 16. In addition, various images can be displayed on the image display area 61 excluding the symbol display area 62 with the image display area 61 excluding the symbol display area 62 in the image-displaying state.

The medal insertion slot 21 and a bill validator 22 are disposed below the display 16. The bill validator 22 validates bills and accepts valid ones. Various operational switches are disposed nearby the medal insertion slot 21 and the bill validator 22.

A cash-out switch 23, a max-bet switch 24, a bet switch 25, a spin/repeat-bet switch 26, and the start switch 27 are provided as the operational switches. In addition, a payout counter 48 is provided to display a payout amount.

The bet switch 25 is a switch for determining a bet amount on each slot game executed by the spinning reel device 3. As will be described later, each time the bet switch 25 is pressed, one bet corresponding to one medal is placed.

The spin/repeat-bet switch 26 is a switch for placing a bet again without changing a bet amount had been placed by the bet switch 25 on the last slot game to play a slot game.

The start switch 27 is a switch for starting a slot game after a bet with desired credits has been placed by the bet switch 25. A slot game, in which each of the reels 3A, 3B and 3C of the spinning reel device 3 starts to spin and then stops, is started after a medal(s) was inserted into the medal insertion slot 21 or a bet was placed by the bet switch 25 and the start switch 27 has been pressed.

The cash-out switch 23 is a switch for cashing out awarded medals being inserted. The medals to be cashed out are discharged from a medal cash-out chute 19 opened in the front lower part of the main door 13 and pooled on a medal tray 18.

The max-bet switch 24 is a switch for betting the maximum bet amount (e.g., thirty credits) that can be placed on a single game play by one pressing.

The payout counter 48 displays a payout amount in case where a specific symbol combination has been achieved as a result of an execution of a slot game.

A foot display 34 is disposed on the lower front of the main door 13. Various images relating to the game of the slot machine 10, such as characters of the slot machine 10 and so on, are displayed on the foot display 34. The medal cash-out chute 19 and the medal tray 18 are disposed below the foot display 34.

An upper display 33 is disposed on the front of the top box 12. The upper display 33 has a display panel and displays the numbers of medals to be paid out corresponding to symbol combinations etc.

Speakers 29 are provided on the top box 12. A ticket printer 35, a card reader 36, a data display 37 and a keypad 38 are disposed below the upper display 33. The ticket printer 35 prints out a bar-code ticket 39 including data such as a credit amount, time and date, identification number of the slot machine 10 printed thereon as a bar code.

The player can play a game at another slot machine by using the bar-code ticket 39, and exchange the bar-code ticket 39 for bills at a predetermined site in an amusement facility (e.g., a cashier in the casino).

A smart card can be inserted into the card reader 36. The card reader 36 reads data from the inserted smart card and writes data onto the smart card. The smart card is carried by the player and stores the player's identification data, gaming history data of the games played by the player and so on.

FIG. 3 is a block diagram illustrating the electric configuration of the controller 40 and various components connected to the controller 40, which are provided within the slot machine 10 of the present embodiment. The controller 40 of the slot machine 10 shown in FIG. 3 is a microcomputer and includes interface circuits 102, an input/output (I/O) bus 104, a CPU 106, a ROM 108, a RAM 110, a signal communication interface (I/F) circuit 111, a random number generator (RNG) 112, a motor drive circuit 51, a reel position detecting circuit 52, a display controller 140, a hopper drive circuit 124, a speaker drive circuit 122 and a display control circuit 128.

The interface circuits 102 are connected to the I/O bus 104. The I/O bus 104 transmits data signals and address signals with the CPU 106.

The start switch 27 is connected to the interface circuits 102. A start signal output from the start switch 27 is transmitted to the CPU 106 via the I/O bus 104 after having been converted into a predetermined signal by the interface circuits 102.

Furthermore, the bet switch 25, the max-bet switch 24, the spin/repeat-bet switch 26 and the cash-out switch 23 are connected to the interface circuits 102. A switching signal output from each of the switches 23 to 26 is transmitted to the CPU 106 via the I/O bus 104 after having been converted into a predetermined signal by the interface circuits 102.

In addition, a medal sensor 43 is connected to the interface circuits 102. The medal sensor 43 detects a medal(s), which has been inserted into the medal insertion slot 21. The medal sensor 43 is provided inside the medal insertion slot 21 (see FIG. 2). The detection signal output from the medal sensor 43 is transmitted to the CPU 106 via the I/O bus 104, after having been converted into a predetermined signal by the interface circuits 102.

In addition, the ROM 108 storing system programs and the RAM 110 storing various data are connected to the I/O bus 104. Furthermore, the RNG 112, the signal communication I/F circuit 111, the motor drive circuit 120, the display controller 140, the hopper drive circuit 124, the speaker drive circuit 122, and the display control circuit 128 are connected to the I/O bus 104.

The CPU 106 is triggered by receiving the start signal from the start switch 27 to read a game execution program stored in the ROM 108 and execute a game. The game execution program is a program for executing the slot game in which the reels 3A, 3B and 3C are spinning and then stopped and various effect images are displayed on the image display area 61.

In other words, the game execution program is programmed to execute a slot game in which symbols drawn on the circumferential surface of the reels 3A, 3B and 3C are scrolled by spinning the reels 3A, 3B and 3C, then the reels 3A, 3B and 3C are stopped sequentially in the order “3A”, “3B”, “3C” and an award is provided or a bonus game is executed when the stopped symbols displayed through the symbol display area 62 brings a winning combination (e.g., symbol combination “7”-“7”-“7”).

The signal communication I/F circuit 111, which is connected to a hall server etc., transmits gaming history data of the slot machine 10 and so on to the hall server. The signal communication I/F circuit 111 receives various data transmitted from the hall server.

The RNG 112 generates a random number for determining whether or not to achieve a winning combination in the slot game executed by the spinning reel device 3.

The display control circuit 128 controls displaying a payout amount on the payout counter 48 provided at the lower left on the display 16

The speaker drive circuit 122 outputs sound data to the speakers 29. In other words, the CPU 106 reads the sound data stored in the ROM 108 and transmits the sound data to the speaker drive circuit 122 via the I/O bus 104. In this manner, predetermined sound effects are generated via the speakers 29.

The hopper drive circuit 124 outputs a cash-out signal to the hopper 44 when providing a cash-out. In other words, the CPU 106 outputs a drive signal to the hopper drive circuit 124 via the I/O bus 104 when receiving the cash-out signal from the cash-out switch 23. As a result, the hopper 44 cashes out medals equivalent to the credits stored at that time in a predetermined memory area of the RAM 110.

The display controller 140 controls displaying a various effect images in the image display area on the display 16. In detail, the CPU 106 generates an image display signal according to status and an outcome of the slot game and outputs the image display signal to the display controller 140 via the I/O bus 104. Upon receipt of the image display signal, the display controller 140 generates a drive signal of the display 16 based on the image display signal. And then, the display controller 140 outputs the drive signal to the display 16. In this manner, prescribed images are displayed on the display 16.

In addition, the display controller 140 controls switching of the image display area 61 between the transmissive state and the image-displaying state. In detail, the reels 3A, 3B and 3C spinning behind the image display area 61 can be seen from the front of the slot machine 10 when the display controller 140 set the symbol display area 62, which is a partial area of the image display area 61 in front of the spinning reel device 3, in the transmissive state. In addition, effect images can be displayed in the symbol display area 62 when the display controller 140 set the symbol display area 62 in the image-displaying state according to producing patterns of various images. For example, a “HIT” image 202 shown in FIG. 1D can be displayed. In this case, the reel 3C behind the symbol display area 62 in the image-displaying state cannot be seen.

The motor drive circuit 51 drives stepping motors 56a to 56c. The motor drive circuit 51 generates a drive signal for driving the stepping motors 56a to 56c according to a signal output from the CPU 106. And then the motor drive circuit 51 outputs the generated drive signal to the stepping motors 56a to 56c. In this manner, the stepping motors 56a to 56c are driven. The stepping motors 56a to 56c is coupled with the reels 3A to 3C on which symbols are drawn, respectively, and a slot game proceeds with the reels 3A to 3C spinning.

In addition, each of the reels 3A to 3C is provided with a magnetic tape 55 storing magnetic data for specifying symbol positions on its appropriate portion. Magnetic sensors 54a to 54b are respectively provided at opposite positions against the magnetic tapes 55 to read-out the magnetic data stored in the magnetic tapes 55. Each of the magnetic sensors 54a to 54c is connected to the reel position detecting circuit 52. Therefore, the reel position detecting circuit 52 is capable of detecting rotational positions of the reels 3A to 3C based on the magnetic data read-out by the magnetic sensors 54a to 54c.

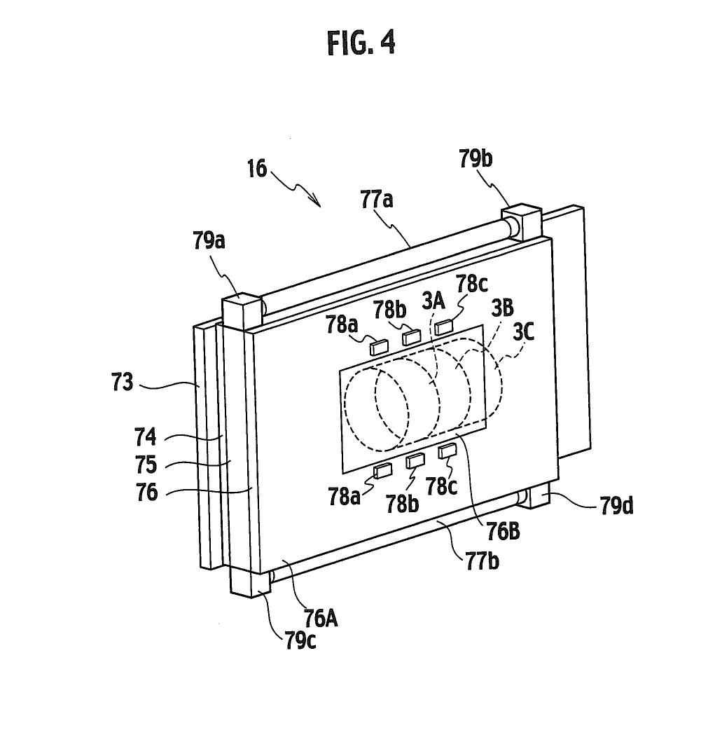

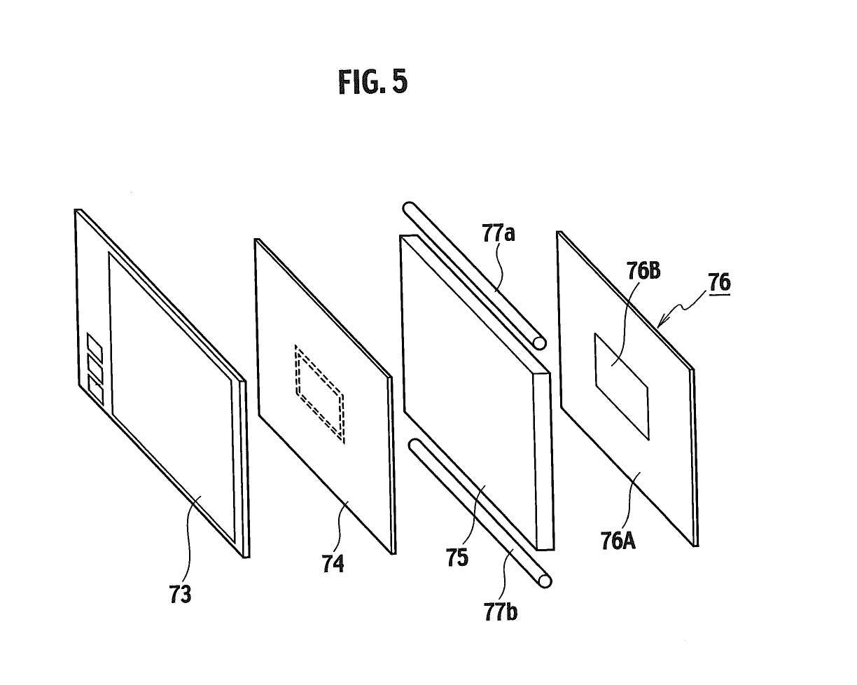

FIG. 4 is a perspective view with the display 16 viewed from behind. FIG. 5 is an exploded perspective view of the display 16 shown in FIG. 4. Note that some elements shown in FIG. 4 are omitted to be drawn in FIG. 5.

As shown in FIGS. 4 and 5, the display 16 is composed of a display panel 73, a transmissive liquid crystal panel 74, a light guide plate 75 and a reflective film 76 in the order from the front side of the slot machine 10. In addition, the spinning reel device 3 including the reels 3A, 3B and 3C is provided behind the display 16.

Furthermore, the display 16 includes fluorescent tubes 77a, 77b and lamp holders 79a to 79d to support these fluorescent tubes 77a, 77b on the top and the bottom of the light guide plate 75.

The display panel 73 displays various effect images as the image display area 61 and is constituted by a transparent material. Since the partial area in the image display area 61 in front of the reels 3A, 3B and 3C (the symbol display area 62) is normally in the transmissive state, the symbols drawn on the reels 3A, 3B and 3C can be seen through the symbol display area 62. In addition, various images can be displayed on the image display area 61 excluding the symbol display area 62 with the image display area 61 excluding the symbol display area 62 in the image-displaying state.

The transmissive liquid crystal panel 74 is constituted by filling liquid crystal between a transparent substrate, such as a glass plate on which a thin film transistor layer is formed, and another transparent substrate in opposition thereto. The transmissive liquid crystal panel 74 is normally set colorless in an inactive state in which no image is displayed by the liquid crystal. Therefore, it becomes colorless when the liquid crystal is inactive, transmitted light toward the front can be visually recognized from the outside. This state is the transmissive state. Specifically, the symbol display area 62 disposed on the almost center of the transmissive liquid crystal panel 74 is set in an inactive state with being transmissive in order for a player to be able to see the reels 3A, 3B and 3C when a slot game is executed. Otherwise, the symbol display area 62 can be set in an active state to display various images appropriately.

The light guide plate 75 guides the light from the fluorescent tubes 77a, 77b to the transmissive liquid crystal panel 74 in order to illuminate the transmissive liquid crystal panel 74. Specifically, the light guide plate 75 is a transparent member, such as acryl resin, having a thickness of about two centimeters and made of a material having light guiding feature.

The reflective film 76 is, for example, a white polyester film or an aluminum thin film with a vapor-deposited silver film to reflect the light guided into the light guide plate 75 toward the front of the light guide plate 75. The reflective film 76 includes a reflective area 76A and a non-reflective area 76B. The non-reflective area 76B is made of a transparent material and disposed on an area corresponding to the reels 3A, 3B and 3C.

Fluorescent tubes 77a, 77b are disposed along an upper end and a lower end of the light guide plate 75 and both ends of them are supported by the lamp holders 79e to 79h. The light from the fluorescent tubes 77a, 77b is reflected by the reflective area 76A of the reflective film 76 to illuminate the transmissive liquid crystal panel 74.

Lamps 78a, 78b and 78c, which are configured by LED's and so on, are provided above and below each of the reels 3A, 3B and 3C on the back surface of the reflective film 76. The lamps 78a, 78b and 78c are arranged to emit light toward the reels 3A, 3B and 3C. The light emitted from the lamps 78a, 78b and 78c is reflected by the surfaces of the reels 3A, 3B and 3C. Some of the light reflected by the surfaces of the reels 3A, 3B and 3C enters the non-reflective area 76B to illuminate the transmissive liquid crystal panel 74.

In fact, if an area in front of the reels 3A, 3B and 3C on the transmissive liquid crystal panel 74 (the symbol display area 62) is set colorless and all of the lamps 78a, 78b and 78c provided above and below the reels 3A, 3B and 3C are lit up, the symbol display area 62 is set in the transmissive state in order for a player to be able to see the reels 3A, 3B and 3C behind the transmissive liquid crystal panel 74.

Otherwise, if a effect image is displayed in the symbol display area 62 on the transmissive liquid crystal panel 74 and one pair of the lamps 78a, 78b and 78c corresponding to one of the reels 3A, 3B and 3C just behind the effect image is extinguished, a player cannot see that reel and can see only the effect image displayed on the symbol display area 62. For example, when an image is displayed on the symbol display area 62 in front of the reel 3C and the lamps 78c provided above and below the reel 3C are extinguished, a player can see the image displayed on the symbol display area 62 in front of the reel 3C. In other words, an area within the symbol display area 62 in front of the reel 3C is set in the image-displaying state. As explained above, the image display area 61 is set in the transmissive state or the image-displaying state.

The reels 3A, 3B and 3C of the spinning reel device 3 are configured mechanically. The reels 3A, 3B and 3C are provided at predetermined intervals. The reels 3A, 3B and 3C are drum-shaped and coupled with stepping motors 56a, 56b and 56c, respectively. Therefore, the reels 3A, 3B and 3C spin according to rotations of the stepping motors 56a, 56b and 56c, respectively.

Plural symbols such as “7”, “APPLE”, “BELL”, “CHERRY” and so on are drawn on each circumferential surface of the reels 3A, 3B and 3C. A player can see the symbols scrolling at each of the reels 3A, 3B and 3C due to spinning of the reels 3A, 3B and 3C.

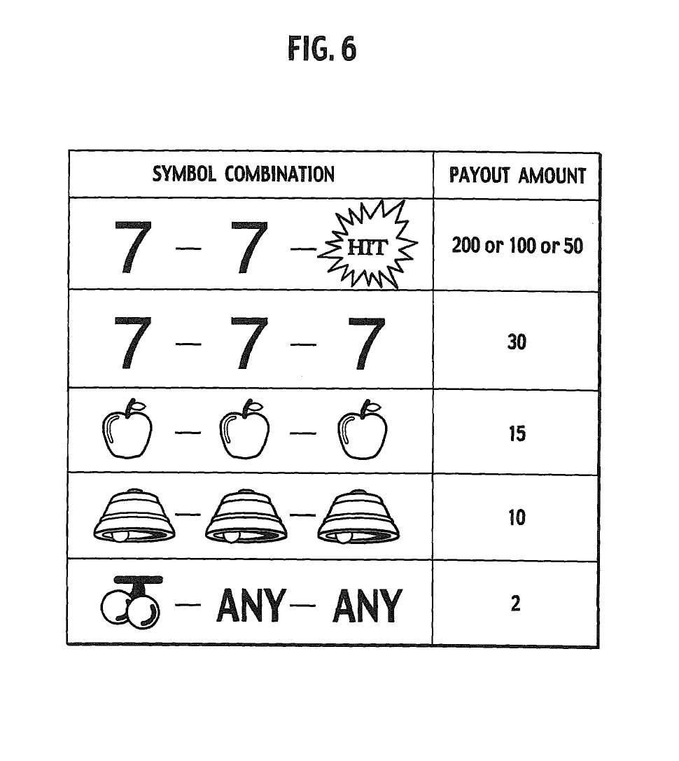

Next, winning symbol combinations by the stopped reels 3A, 3B and 3C will be explained. FIG. 6 is an explanatory diagram showing a payout table. As shown in FIG. 6, thirty medals will be awarded per one bet when a “7-7-7” symbol combination is displayed when the reels 3A, 3B, 3C has stopped. Fifteen medals will be awarded per one bet when an “APPLE-APPLE-APPLE” symbol combination is displayed. Ten medals will be awarded per one bet when a “BELL-BELL-BELL” symbol combination is displayed. Two medals will be awarded per one bet when a “CHERRY” symbol is displayed in the left (any symbol in the center and the right).

Furthermore, a payout will be awarded according to a displayed effect image when each of the reels 3A and 3B has stopped at “7” and a “HIT” image is displayed in front of the reel 3C on the symbol display area 62, in other words, in case of a “7-7-HIT” symbol combination. As explained later, fifty medals will be awarded per one bet when a “little bird” image is displayed as the effect image and then the “little bird” is hit. One hundred medals will be awarded per one bet when an “eagle” image is displayed as the effect image and then the “eagle” is hit. Two hundred medals will be awarded per one bet when a “butterfly” image is displayed as the effect image and then the “butterfly” is hit.

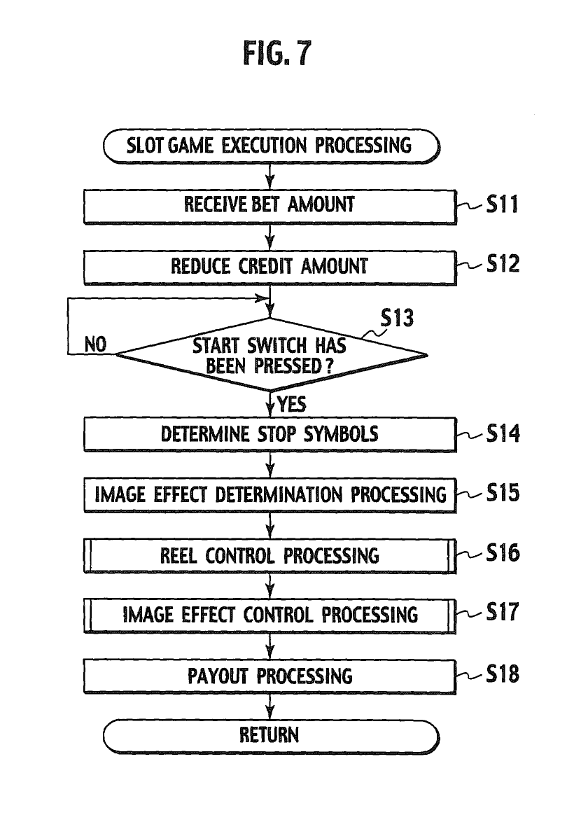

Next, operations of a slot machine according to a first embodiment will be explained with reference to FIGS. 7, 8 and 9. FIG. 7 is a flow-chart showing processes of slot game execution processing executed by the slot machine according to the first embodiment.

First, the CPU 106 shown in FIG. 3 accepts a bet of a medal(s) or a credit(s) by a player (step S11). Specifically, a bet amount is receive when the player places a bet with a desired credit amount by pressing the bet switch 25 or a bet with a medal amount by inserting a medal(s) into the medal insertion slot 21.

The CPU 106 reduces counted credits by the credits amount in case where the bet has been placed by pressing the bet switch 25 (step S12). For example, when a bet of ten credits has been placed under thirty credits, the counted credits become twenty credits by reducing.

The CPU 106 determines whether or not the start switch 27 has been pressed (step S13). If the start switch 27 has been pressed, stop symbol determination processing is executed (step S14). In this processing, stop symbols to be stopped at the reels 3A, 3B and 3C, in other words symbols to be displayed through the symbol display area 62, are determined based on random values generated by the RNG 112.

The CPU 106 executes image effect determination processing (step S15). In this processing, an image effect to be presented in the image display area 61 is determined. For example, in case where a symbol combination determined in the stop symbol determination processing is a symbol combination which would achieve a winning combination if one of the symbols were replaced, the image effect is determined in which a predetermined image (a “little bird” image, an “eagle” image or a “butterfly” image and so on) is to be displayed in the image display area 61.

The CPU 106 executes reel control processing (step S16). In this processing, spinning and stopping of the reels 3A, 3B and 3C are controlled so that the symbols determined in the stop symbol determination processing may be stopped at positions visible through the symbol display area 62 in front of the reels 3A, 3B and 3C.

The CPU 106 executes image effect control processing (step S17). In this processing, the image for the image effect determined in the image effect determination processing of step S15 is displayed in the image display area 61. This will be explained later in detail.

The CPU 106 determines a payout amount of medals according to the stop symbols of the reels 3A, 3B and 3C visible through the symbol display area 62 and the image displayed in the image display area 61, and then payouts medals determined (step S18) In this manner, the slot game is executed.

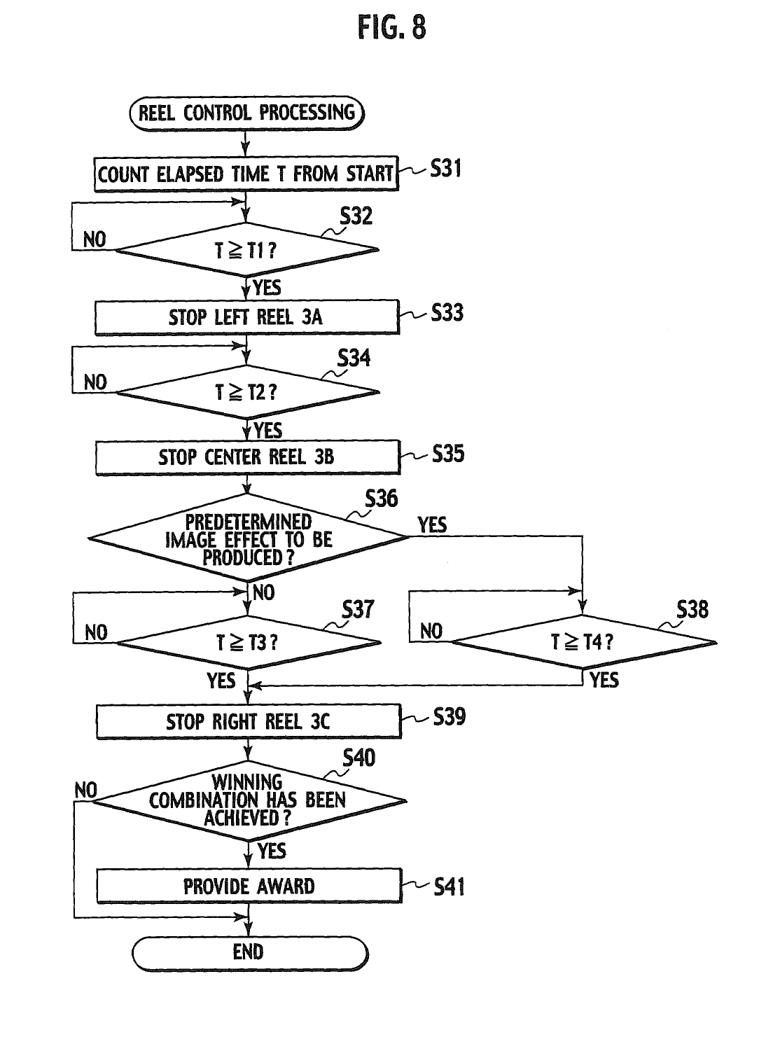

Next, the reel control processing of step S16 in FIG. 7 will be explained with reference to a flow-chart shown in FIG. 8.

The CPU 106 counts an elapsed time T since the start switch 27 has been pressed (step S31). Then the CPU 106 determines whether or not the elapsed time T has been reached a preset time T1 (step S32).

If the elapsed time T has reached the time T1, the CPU 106 stops the left reel 3A (step S33). Then the CPU 106 determines whether or not the elapsed time T has reached a preset time T2 (T2>T1) (step S34).

If the elapsed time T has reached the time T2, the CPU 106 stops the center reel 3B (step S35). Then the CPU 106 determines whether or not an execution of the image effect (for example, the effect with the “eagle” image moving) has been determined in the image effect determination processing (step S15 in FIG. 7) (step S36). If the predetermined image effect is not to be produced (NO in step S36), the CPU 106 determines whether or not the elapsed time T has reached a preset time T3 (T3>T2) (step S37). Then the CPU 106 stops the right reel 3C (step S39).

Otherwise, if the predetermined image effect is to be produced (YES in step S36), the CPU 106 determines whether or not the elapsed time T has reached a preset time T4 (T4>T3) (step S38). If the elapsed time T has reached the preset time T4, the CPU 106 stops the right reel 3C (step S39). In other words, the reel 3C is controlled so that its stop timing may be made later in case where the image effect is to be produced than in case where the image effect is not to be produced.

Then the CPU 106 determines whether or not a symbol combination by the stopped reels 3A, 3B and 3C has brought a winning combination (step S40). Specifically, it is determined whether or not the symbol combination has brought one of winning combinations defined in the payout table shown in FIG. 6. Then, if a winning combination has been brought, an award is provided (step S41). The provided award will be paid out in the payout processing of step S18 in FIG. 7. In this manner, the reel stop control processing for stopping the reels 3A, 3B and 3C is executed.

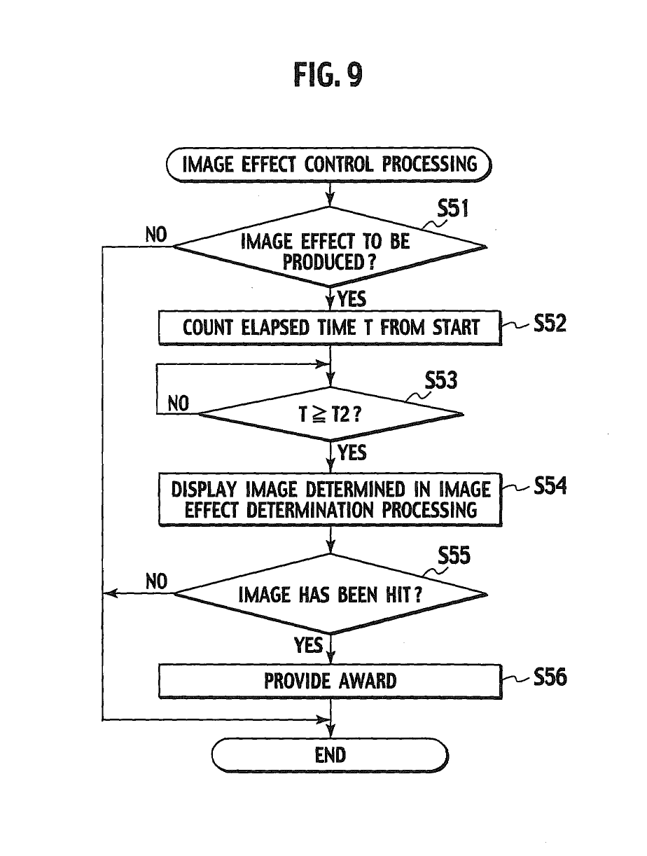

Next, the image effect control processing of step S17 in FIG. 7 will be explained with reference to a flow-chart shown in FIG. 9.

First, the CPU 106 determines whether or not the execution of the image effect has been determined in the image effect determination processing of step S15 in FIG. 7 (step S51). If the image effect is not to be produced, this processing is terminated.

If the image effect is not to produced (YES in step S51), the CPU 106 counts the elapsed time T since the start switch 27 has been pressed (step S52). Then the CPU 106 determines whether or not the elapsed time T has been reached a preset time T2 (step S53). If the elapsed time T has reached the time T2 (YES in step S53), the CPU 106 displays the image determined in the image effect determination processing on the image display area 61 (step S54). Here, as explained with FIG. 8, since the time T2 is the stop timing of the center reel 3B, the image effect is started at the time when the left reel 3A and the center reel 3B have been stopped.

The CPU 106 determines whether or not the “HIT” image is displayed when the image (for example, the “eagle” image) displayed on the image display area 61 has reached an area in front of the right reel 3C (step S55).

As a result, if the “HIT” image is displayed (YES in step S55), the CPU 106 provides an award (step S56). At this time, the image display area in front of the right reel 3C is shifted from the transmissive state to the image-displaying state. Therefore, the stop symbol of the reel 3C cannot be seen and the “HIT” image displayed in front thereof on the symbol display area 62 can be seen.

Otherwise, if the “HIT” image is not displayed (NO in step S55), the CPU 106 terminates this processing without providing an award. In this manner, the image effect control processing is executed.

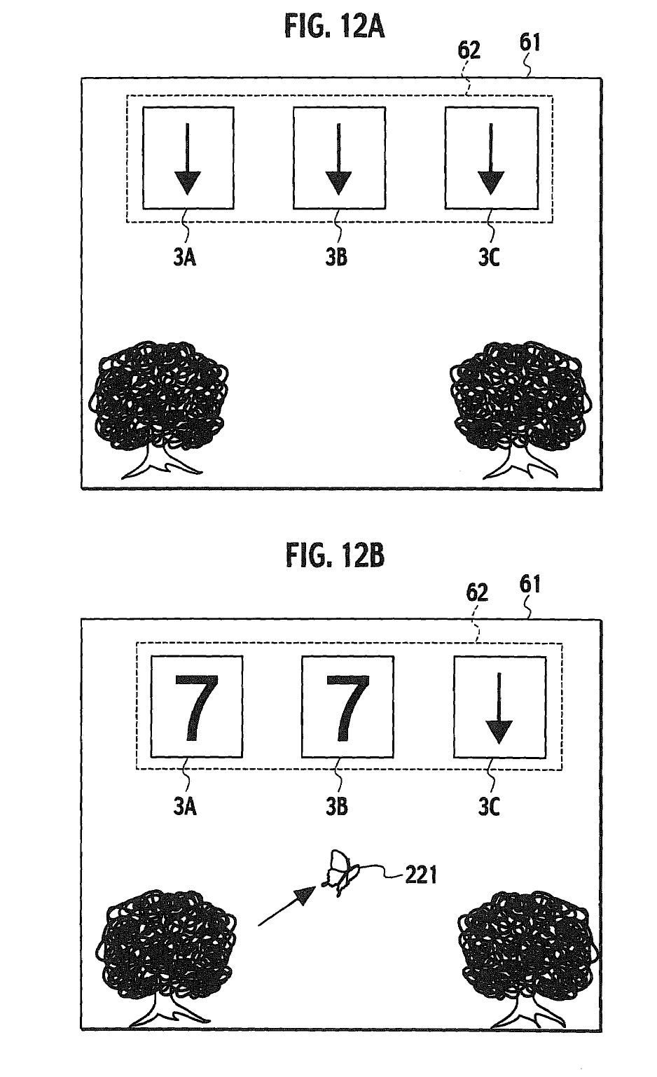

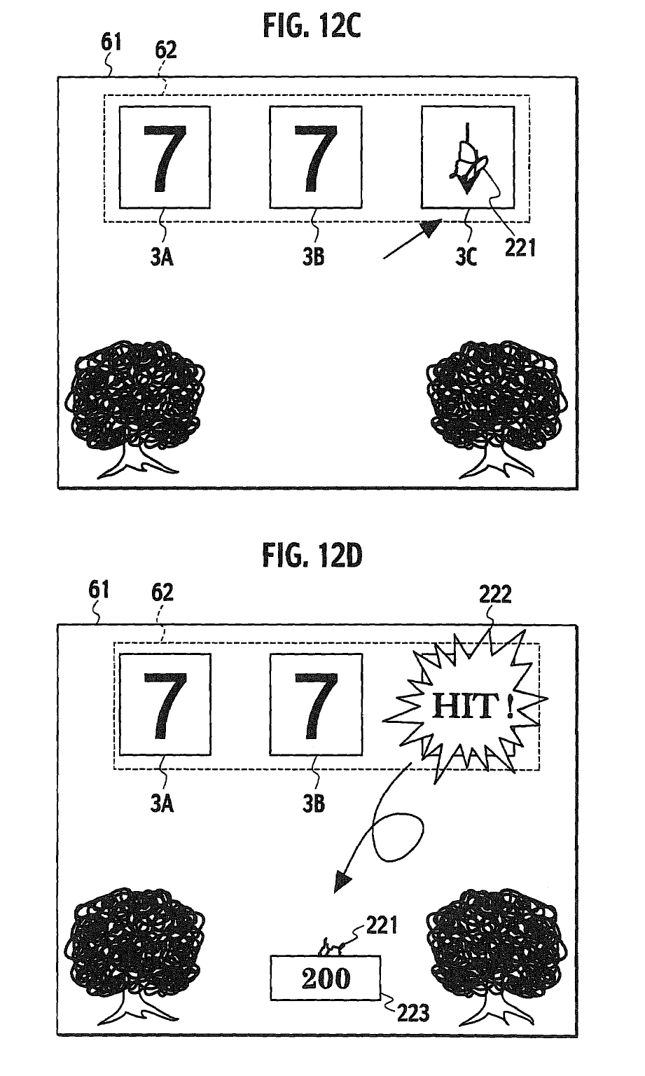

Next process flows shown in FIGS. 8 and 9 will be explained with reference to screen examples shown in FIGS. 1A to 1D, FIGS. 10A to 10D, FIGS. 11A to 11D and. FIGS. 12A to 12D. FIGS. 1A to 1D are the screen image examples which show the case where the execution of the image effect is determined at step S15 in FIG. 7 and the “HIT” image is displayed at step S55 in FIG. 9.

As shown in FIG. 1A, the reels 3A, 3B and 3C start spinning after the start switch 27 has been pressed. The “tree” images are displayed at right and left lower areas in the image display area 61 at this time.

Then the reel 3A stops when the time T1 has been elapsed from a spinning start of the reels 3A, 3B and 3C. The reel 3B stops when the time T2 (the time T2 at step S34 in FIG. 8 and at step S53 in FIG. 9) has been elapsed from the spinning start of the reels 3A, 3B and 3C. Consequently, as shown in FIG. 1B, the left reel 3A and the center reel 3B have stopped and the stop symbols of the reels 3A and 3B are displayed through the symbol display area 62. The left reel 3A has stopped at the “7” symbol and the center reel 3B has also stopped at the “7” symbol in the example shown in FIG. 1B.

Therefore, a winning combination would be achieved if the last reel 3C stopped at the “7” symbol. In this case, the “eagle” image 201 is displayed at the lower area in the image display area 61 and then gradually moves toward the symbol display area 62 in front of the reel 3C.

Then, when the “eagle” image 201 has reached the symbol display area 62 in front of the reel 3C as shown in FIG. 1C, the spinning reel 3C comes to a stop and the “HIT” image 202 is displayed in front of the reel 3C on the symbol display area 62. After that, the “eagle” image 201 drops and the “100” image 203 indicating the number of medals to be paid out is displayed at the drop position. In other words, an award corresponding to one hundred medals is provided when the symbol combination “7-7-HIT” has been achieved.

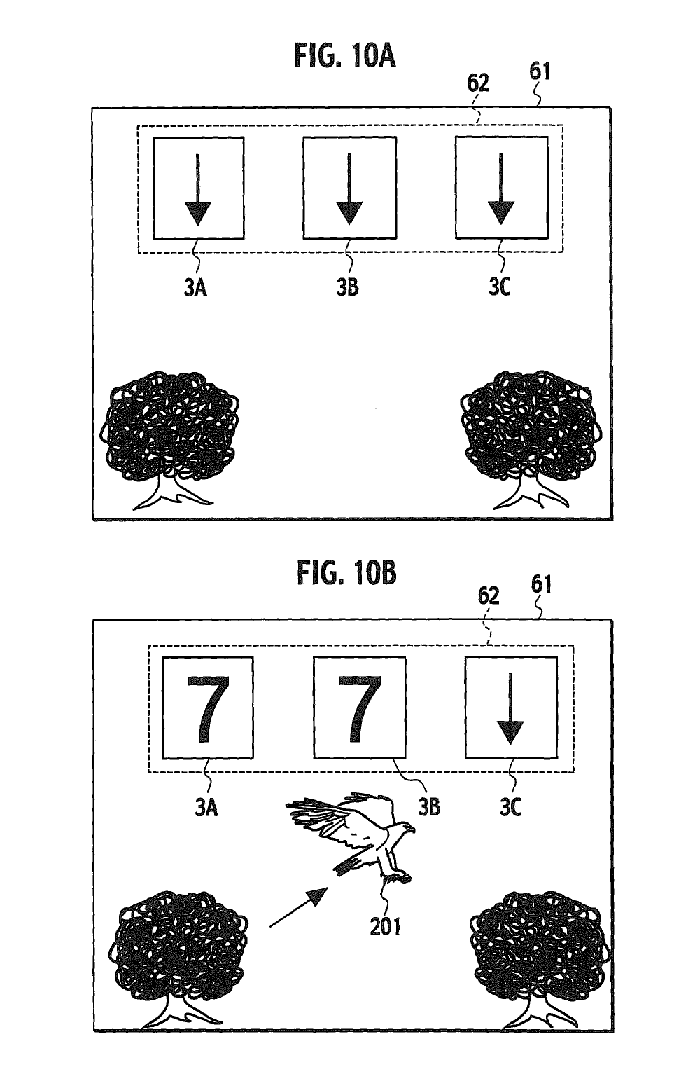

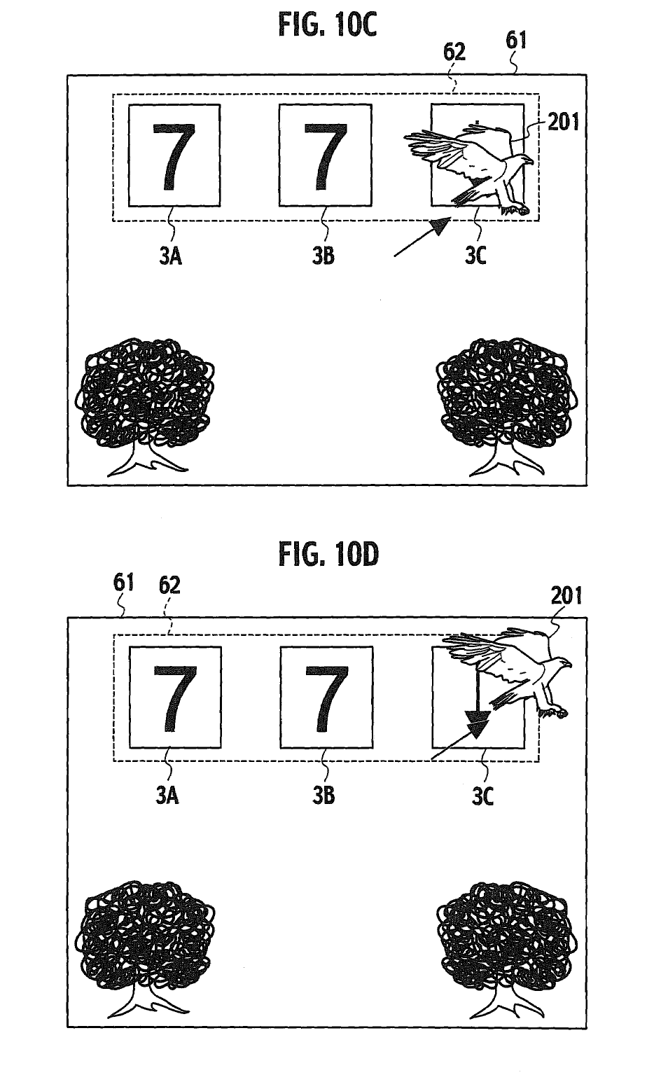

FIGS. 10A to 10D are the screen image examples which show the case where the execution of the image effect is determined at step S15 in FIG. 7 and the “HIT” image is not displayed at step S55 in FIG. 9. As shown in FIG. 10A, the reels 3A, 3B and 3C start spinning after the start switch 27 has been pressed. The “tree” images are displayed at right and left lower areas in the image display area 61 at this time.

Then the reel 3A stops when the time T1 has been elapsed from a spinning start of the reels 3A, 3B and 3C. The reel 3B stops when the time T2 has been elapsed from the spinning start of the reels 3A, 3B and 3C. Consequently, as shown in FIG. 10B, the left reel 3A and the center reel 3B have stopped and the stop symbols of the reels 3A and 3B are displayed through the symbol display area 62. The left reel 3A has stopped at the “7” symbol and the center reel 3B has also stopped at the “7” symbol in the example shown in FIG. 10B.

Therefore, a winning combination would be achieved if the last reel 3C stopped at the “7” symbol. In this case, the “eagle” image 201 is displayed at the lower area in the image display area 61 and then gradually moves toward the symbol display area 62 in front of the reel 3C.

Then, when the “eagle” image 201 has reached the symbol display area 62 in front of the reel 3C as shown in FIG. 10C, the spinning reel 3C comes to a stop and the “eagle” image 201 passes through the symbol display area 62 in front of the reel 3C. In this case, the “HIT” image is not displayed for missing an award.

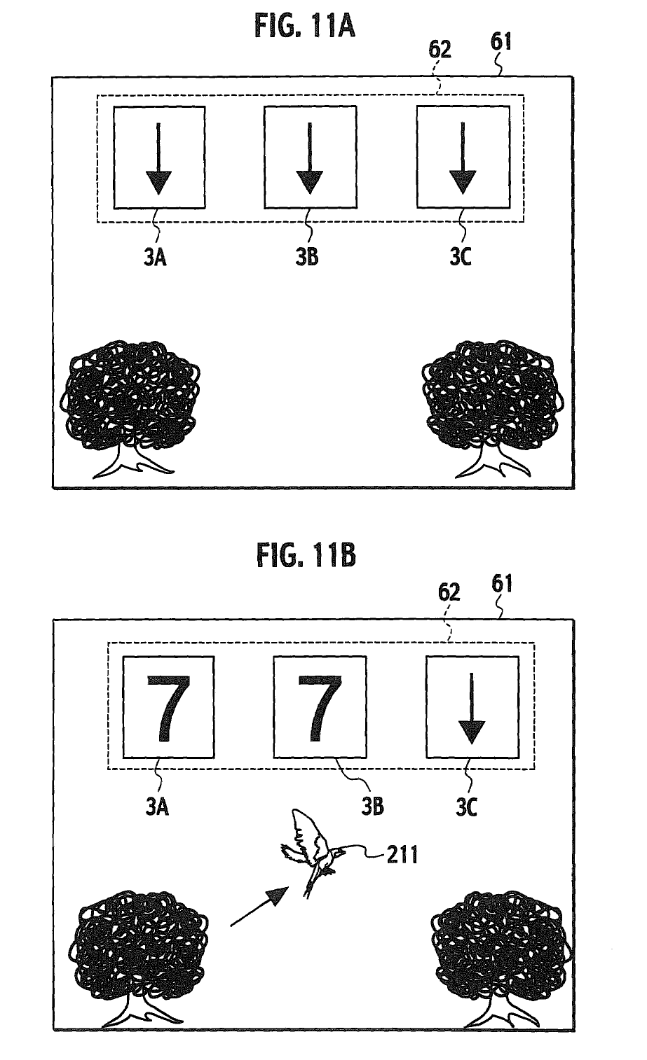

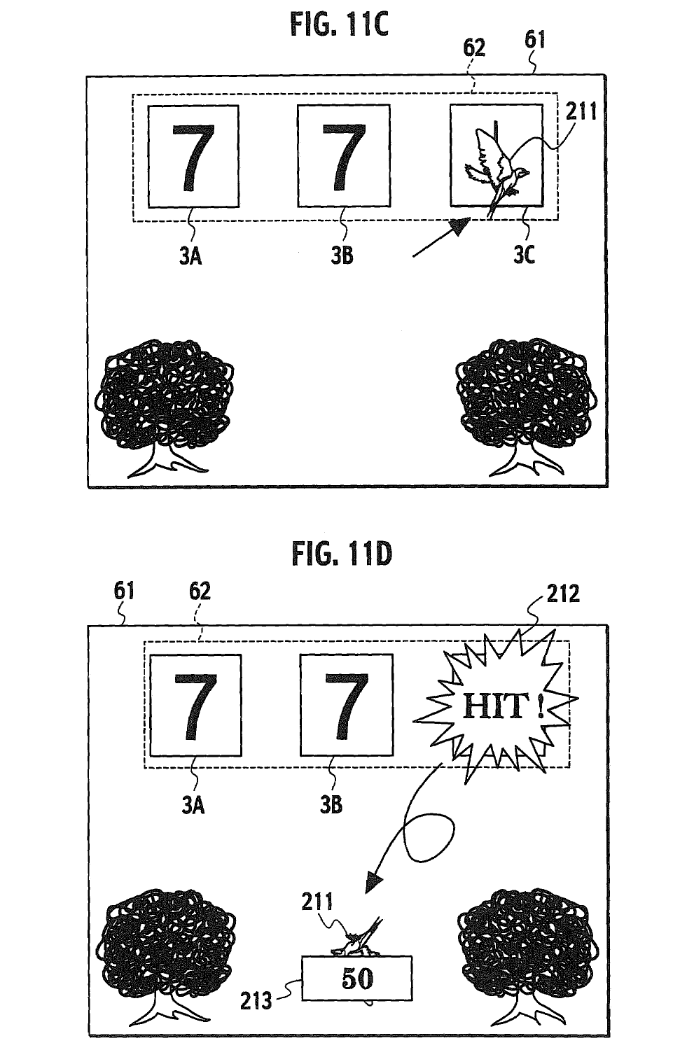

FIGS. 11A to 11D and FIGS. 12A to 12D are the other screen image examples which show the cases where the execution of the image effect is determined at step S15 in FIG. 7 and the “HIT” image is displayed at step S55 in FIG. 9. In the case of FIGS. 1A to 111D, the “little bird” image 211 is displayed as the image for the image effect. If the “little bird” image 211 is hit, a “50” image 213 is displayed as shown in FIG. 11D. In other words, an award corresponding to fifty medals is provided when the symbol combination “7-7-HIT” has been achieved with the effect of the “little bird” image 211.

Similarly in the case of FIGS. 12A to 12D, the “butterfly” image 221 is displayed as the image for the image effect. If the “butterfly” image 221 is hit, a “200” image 223 is displayed as shown in FIG. 12D. In other words, an award corresponding to two hundred medals is provided when the symbol combination “7-7-HIT” has been achieved with the effect of the “butterfly” image 221.

In this manner, in the slot machine according to the first embodiment, since it is determined whether or not an award is to be provided according to the symbol combination displayed through the symbol display area 62 and the effect image displayed on the image display area 61 after the reels 3A, 3B and 3C have come to stops, an entertainment feature can be improved.

Next, a second embodiment of the present embodiment will be explained. The second embodiment is different from the above-mentioned first embodiment in the process procedure of the image effect control processing at step S17 in FIG. 7. Specifically, in the above-mentioned first embodiment, the predetermined payout processing of medals is executed when the symbol combination “7-7-HIT” has been achieved. In the second embodiment, a transition to a bonus game is brought, when the symbol combination “7-7-HIT” has been achieved.

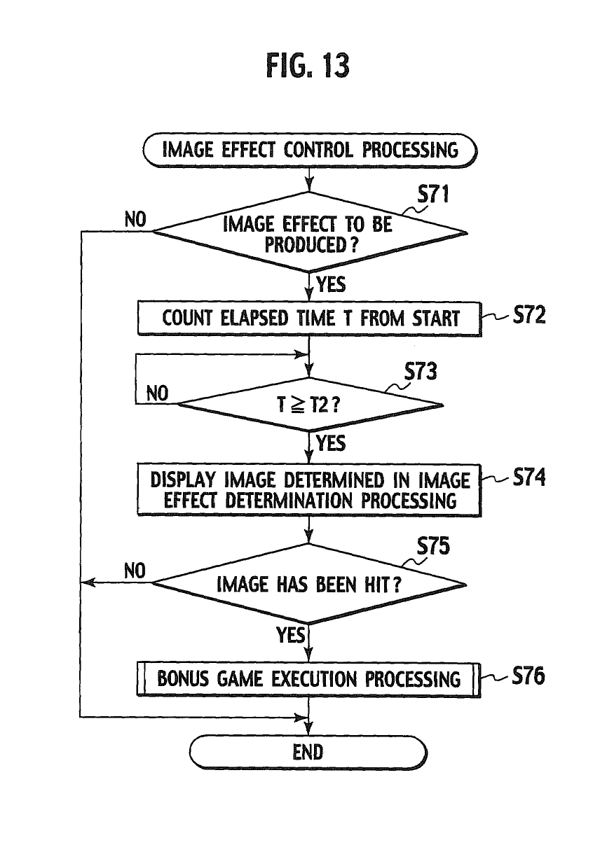

Hereinafter, the process procedure in the image effect control processing in the second embodiment will be explained with reference to a flow-chart shown in FIG. 13.

First, the CPU 106 determines whether or not the execution of the image effect has been determined in the above-mentioned processing of step S15 in FIG. 7 (step S71).). If the image effect is not to be produced (NO in step S71), this processing is terminated.

If the image effect is not to produced (YES in step S71), the CPU 106 counts the elapsed time T since the start switch 27 has been pressed (step S72). Then the CPU 106 determines whether or not the elapsed time T has been reached the preset time T2 (step S73). In other words, it is determined whether or not the left reel 3A and the center reel 3B have come to stops. If the elapsed time T has reached the time T2, the CPU 106 displays the image determined in the image effect determination processing on the image display area 61 (step S74). Here, as explained with above-mentioned FIG. 8, since the time T2 is the stop timing of the center reel 3B, the image effect is started after the left reel 3A and the center reel 3B have been stopped.

The CPU 106 determines whether or not the “HIT” image is displayed when the image (for example, the “eagle” image) displayed on the image display area 61 has reached an area in front of the right reel 3C (step S75).

As a result, if the “HIT” image is displayed (YES in step S75), the CPU 106 executes a bonus game (step S76). At this time, the image display area in front of the right reel 3C is shifted from the transmissive state to the image-displaying state. Therefore, the stop symbol of the reel 3C cannot be seen and the “HIT” image displayed in front thereof on the symbol display area 62 can be seen. Note that bonus game execution processing will be explained later.

Otherwise, if the “HIT” image is not displayed (NO in step S75), the CPU 106 terminates this processing without executing the bonus game. In this manner, the image effect control processing is executed.

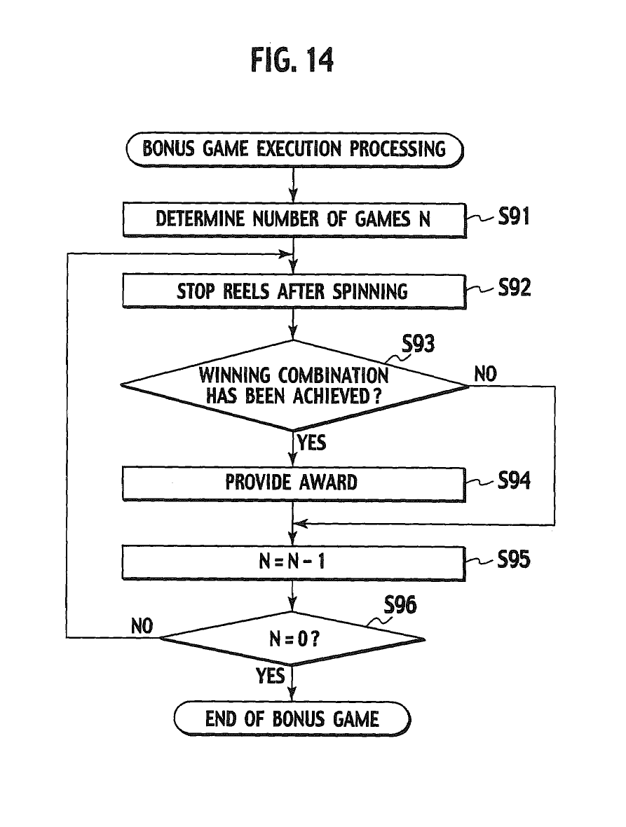

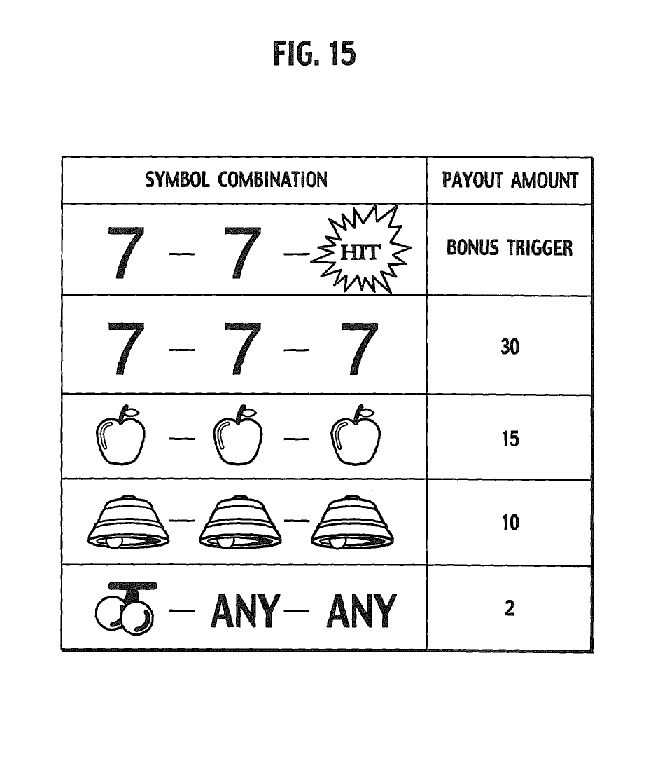

Next, the bonus game execution processing will be explained with reference to a flow-chart shown in FIG. 14.

First, the CPU 106 sets the number of games N of the bonus game and stores it in the RAM 110 shown in FIG. 3 (step S91). The number of games N will be set to ten games in case where the image displayed at step S74 is the “little bird”, twenty games in case where the image is the “eagle” and fifty games in case where the image is the “butterfly”. Note that the number of games may be set randomly based on a generated random number.

Then the CPU 106 starts spinning the reels 3A, 3B and 3C without receiving a bet of a credit(s) or a medal(s) and then stops the reels 3A, 3B and 3C after a predetermined time has elapsed in the order the left reel 3A, the center reel 3B and then the right reel 3C (step S92).

Then the CPU 106 determines whether or not symbols which achieve a winning combination have been displayed on the symbol display area 62 (step S93). If a winning combination has been brought (YES in step S93), the CPU 106 provides an award according to the winning combination (step S94). Specifically, as shown in the payout table of FIG. 6, thirty medals will be awarded per one bet when a “7-7-7” symbol combination is achieved. Fifteen medals will be awarded per one bet when an “APPLE-APPLE-APPLE” symbol combination is achieved. Ten medals will be awarded per one bet when a “BELL-BELL-BELL” symbol combination is displayed. Two medals will be awarded per one bet when a “CHERRY” symbol is displayed in the left (any symbol in the center and the right).

Then the CPU 106 decrements the number of games “N” to “N-1” (step S95). The CPU 106 determines whether or not the number of games “N” has reached “0” (step S96). If not “N=0” (NO in step S96), the process returns to step S92. If “N=0” (YES in step S96), the bonus game is finished. In this manner, the bonus game with the number of games “N” is executed when the “7-7-HIT” symbol combination has been achieved in the slot game.

In this manner, in the slot machine according to the second embodiment, since the transition to a bonus game is brought when the symbols displayed through the symbol display area 62 with the reels stopped and the effect image have achieved a specific combination, an entertainment feature can be improved.

Next, a third embodiment of the present embodiment will be explained. The third embodiment is different from the above-mentioned first embodiment in the slot game execution processing shown in FIG. 7, the reel control processing shown in FIG. 8 and the image effect control processing shown in FIG. 9.

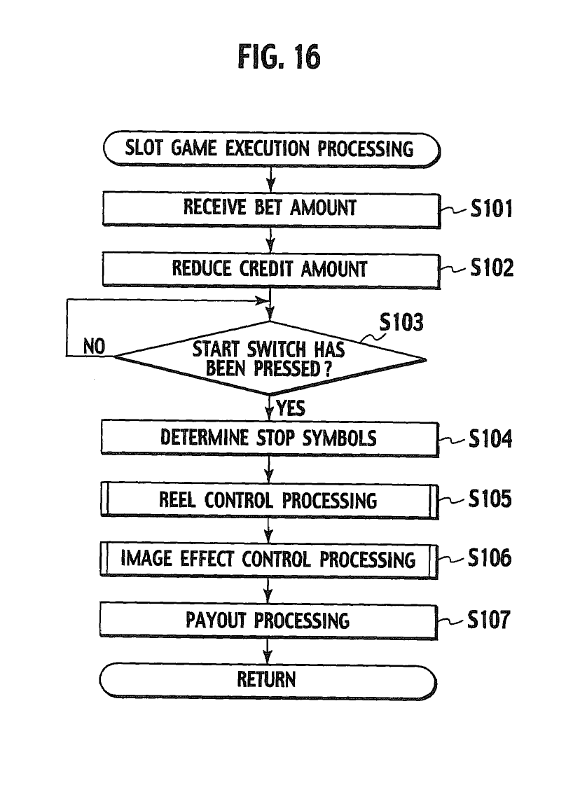

Hereinafter, the slot game execution processing in the third embodiment will be explained with reference to a flow-chart shown in FIG. 16.

First, the CPU 106 shown in FIG. 3 accepts a bet of a medal(s) or a credit(s) by a player (step S101). Specifically, a bet amount is receive when the player places a bet with a desired credit amount by pressing the bet switch 25 or a bet with a medal amount by inserting a medal(s) into the medal insertion slot 21.

The CPU 106 reduces counted credits by the credits amount in case where the bet has been placed by pressing the bet switch 25 (step S102). For example, when a bet of ten credits has been placed under thirty credits, the counted credits become twenty credits by reducing.

The CPU 106 determines whether or not the start switch 27 has been pressed (step S103). If the start switch 27 has been pressed, stop symbol determination processing is executed (step S104). In this processing, stop symbols to be stopped at the reels 3A, 3B and 3C, in other words symbols to be displayed through the symbol display area 62, are determined based on random values generated by the RNG 112.

The CPU 106 executes reel control processing (step S105). In this processing, spinning and stopping of the reels 3A, 3B and 3C are controlled so that the symbols determined in the stop symbol determination processing may be stopped at positions visible through the symbol display area 62 in front of the reels 3A, 3B and 3C.

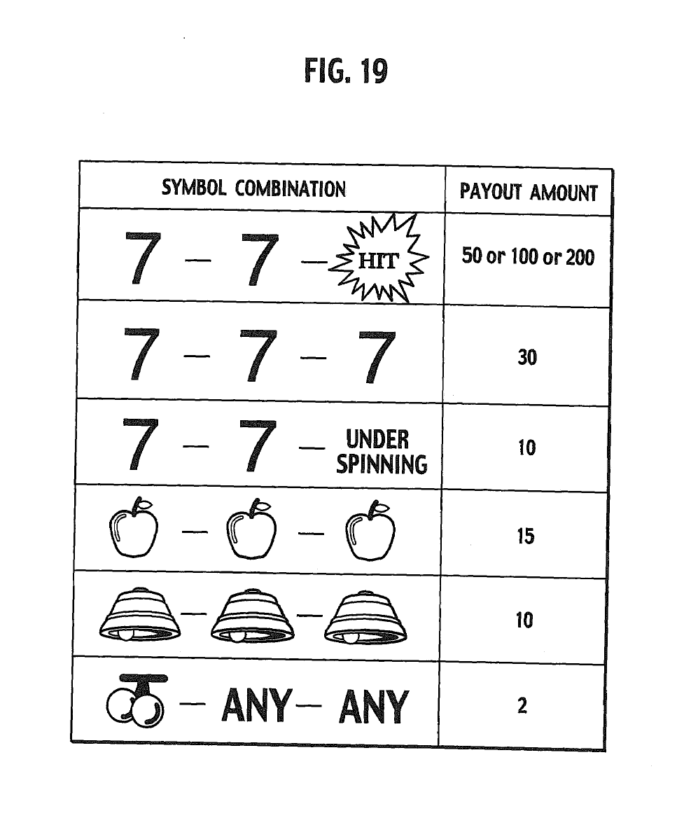

The CPU 106 executes image effect control processing (step S106). In this processing, processing for displaying the image for the image effect in the image display area 61 is executed in case where symbols which achieve a winning combination have come to stops at the left reel 3a and the center reel 3B (for example, a winning combination shown in the fourth row from the bottom in FIG. 19). This will be explained later in detail.

Then the CPU 106 determines a payout amount of medals according to the stop symbols of the reels 3A, 3B and 3C visible through the symbol display area 62 and the image displayed in the image display area 61, and then payouts medals determined (step S107). In this manner, the slot game is executed.

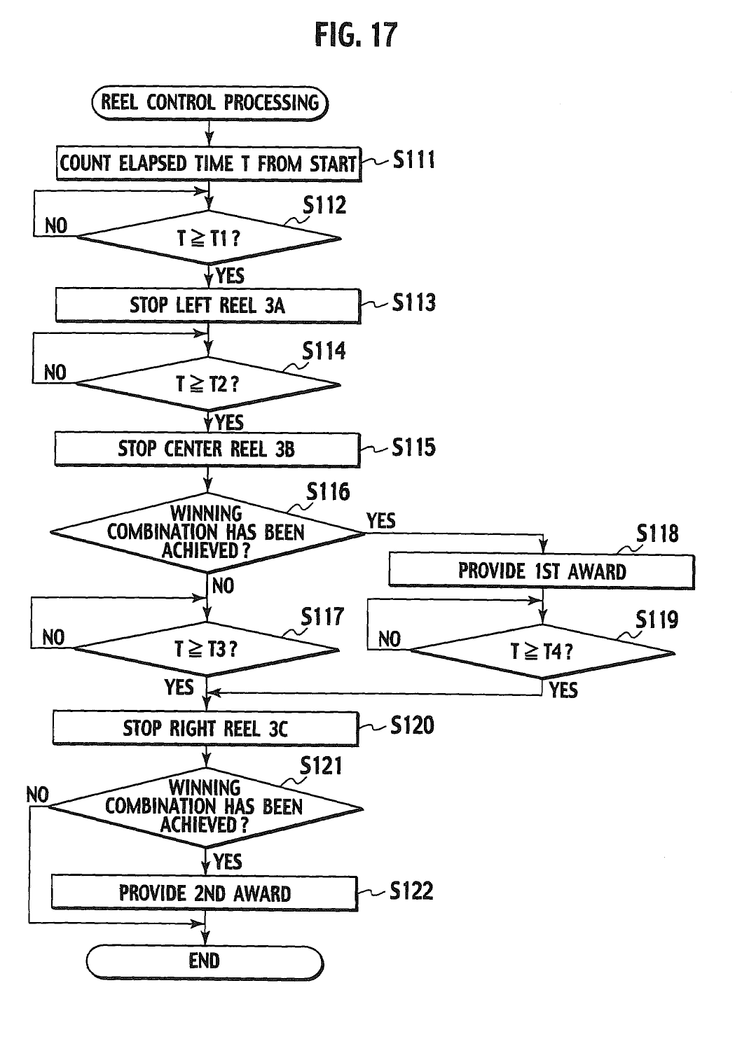

Next, the reel control processing in the third embodiment will be explained with reference to a flow-chart shown in FIG. 17.

The CPU 106 counts the elapsed time T since the start switch 27 has been pressed (step Sill). Then the CPU 106 determines whether or not the elapsed time T has been reached a preset time T1 (step S112).

If the elapsed time T has reached the time T1, the CPU 106 stops the left reel 3A (step S113). Then the CPU 106 determines whether or not the elapsed time T has reached the preset time T2 (T2>T1) (step S114).

If the elapsed time T has reached the time T2, the CPU 106 stops the center reel 3B (step S115). Then the CPU 106 determines whether or not a winning combination “7-7” has been achieved at the left reel 3A and the center reel 3B (step S116). If the winning combination “7-7” has not been achieved (NO in step S116), the CPU 106 determines whether or not the elapsed time T has reached the preset time T3 (T3>T2) (step S117). Then the CPU 106 stops the right reel 3C (step S120).

Otherwise, if the winning combination “7-7” has been achieved (YES in step S116), the CPU 106 provide a first award (step S118). Specifically, ten medals will be awarded per one bet as shown in a payout table of FIG. 19.

The CPU 106 determines whether or not the elapsed time T has reached the preset time T4 (T4>T3) (step S119). If the elapsed time T has reached the preset time T4, the CPU 106 stops the right reel 3C (step S120).

In other words, the reel 3C is controlled so that its stop timing may be made later in case where the image effect is to be produced than in case where the image effect is not to be produced.

Then the CPU 106 determines whether or not a symbol combination by the stopped reels 3A, 3B and 3C has brought a winning combination (step S121). Then, if a winning combination has been brought, a second award is provided (step S122). For example, thirty medals will be awarded per one bet when a symbol “7” has come to a stop at the reel 3C. In this manner, the reel stop control processing for stopping the reels 3A, 3B and 3C is executed.

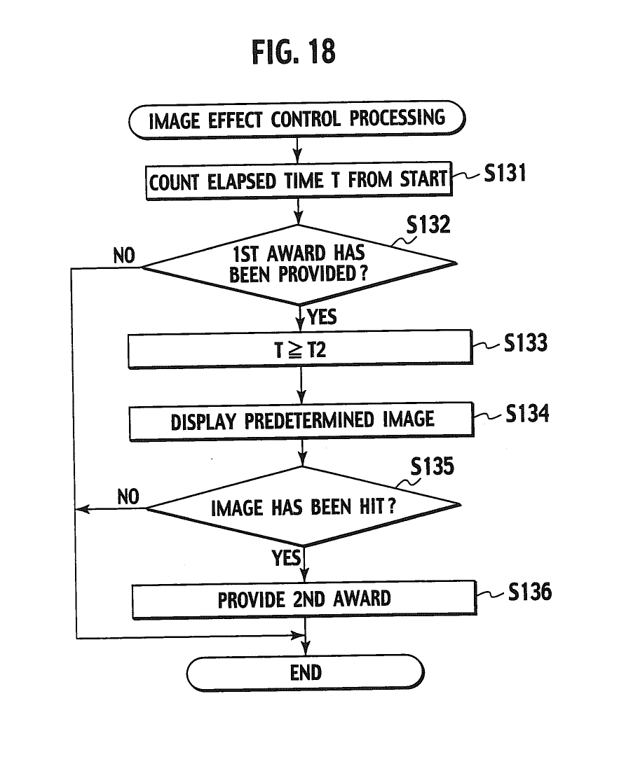

Next, the image effect control processing of step S106 in FIG. 16 will be explained with reference to a flow-chart shown in FIG. 18.

The CPU 106 counts the elapsed time T since the start switch 27 has been pressed (step S132). Then the CPU 106 determines whether or not the first award has been provided in the process at step S118 in FIG. 17 (step S132). If the first award has not been provided, in other words, if the symbols “7-7” have not come to stops at the left reel 3A and the center reel 3B (NO in step S132), the CPU 106 terminates this processing.

Otherwise, if the first award has been provided, in other words, if the symbols “7-7” have come to stops at the left reel 3A and the center reel 3B (YES in step S132), this means that the elapsed time T has already been reached the preset time T2 (step S133). Then the CPU 106 displays a predetermined image such as the “eagle” image, the “little bird” image, the “butterfly image and so on, on the image display area 61 (step S134). Here, as explained with FIG. 17, since the time T2 is the stop timing of the center reel 3B, the image effect with the predetermined image is started at the time when the left reel 3A and the center reel 3B have been stopped.

Then the CPU 106 determines whether or not the “HIT” image is displayed when the image (for example, the “eagle” image) displayed on the image display area 61 has reached an area in front of the right reel 3C (step S135).

As a result, if the “HIT” image is displayed, the CPU 106 provides a second award (step S136). At this time, the image display area in front of the right reel 3C is shifted from the transmissive state to the image-displaying state. Therefore, the stop symbol of the reel 3C cannot be seen and the “HIT” image displayed in front thereof on the symbol display area 62 can be seen. In addition, with respect to the second award as shown in the payout table of FIG. 19, fifty medals will be awarded per one bet when the “little bird” is hit. One hundred medals will be awarded per one bet when the “eagle” is hit. Two hundred medals will be awarded per one bet when the “butterfly” is hit.

Otherwise, if the “HIT” image is not displayed, the CPU 106 terminates this processing without providing a second award. In this manner, the payout processing, in which the first and second awards have already been added up, will be executed at step S107 in FIG. 16.

In this manner, in the slot machine according to the third embodiment, since the first award is provided when a winning combination has been achieved by the symbols with the left reel 3A and the center reel 3B stopped and the second award is further provided when the predetermined image is hit in front of the reel 3C, an entertainment feature can be improved.

Although embodiments of the present invention have been described as above, they are only presented as specific examples, without particularly limiting the present invention. Specific arrangements of respective units may be changed in design as appropriate. In addition, the effects set forth in the embodiments of the present invention are merely an enumeration of the most preferred effect which occurs from the present invention, and the effects by the present invention is not limited to those set forth in the embodiments of the present invention.

What is claimed is:

1. A slot machine comprising:
plural reels each of which is rotatable and has symbols on its circumferential surface;
a display which
(a) is provided in front of the reels, and
(b) has a image display area including a symbol display area for displaying the symbols of each of the reels,
(c) the image display area being able to be set in a transmissive state or in a image-displaying state for displaying an image; and
a controller operable to execute a slot game in which
the reels are spun and then stopped after a bet has been received, and then
an award is provided or a transition to a bonus game is executed when the symbols in the symbol display area and the image displayed in the image display area have achieved a specific combination.

2. The slot machine according to claim 1, wherein the controller is operable to, when executing the slot game,
set the symbol display area in the transmissive state and set the image display area excluding the symbol display area in the image-displaying state, and
set at least some area within the symbol display area in the image-displaying state in case where an image is to be displayed in front of the reels.

3. The slot machine according to claim 1, wherein the controller is operable to
stop the spinning reels sequentially with time intervals, and
display a specific image on the symbol display area in front of the last-stopped reel among the reels in synchronization with the stop timing of the last-stopped reel in case where the specific combination is to be achieved.

4. A slot machine comprising:
plural reels each of which is rotatable and has symbols on its circumferential surface; and
a display which
(a) is provided in front of the reels, and
(b) has a image display area including a symbol display area for displaying the symbols of each of the reels,
(c) the image display area being able to be set in a transmissive state or in a image-displaying state for displaying an image; and
a controller operable to execute a slot game in which
(A) the reels are spun and then stopped after a bet has been received,
(B) produce a primary effect in which a specific image moves within the image display area when at least one of the symbols in the symbol display area has been a specific symbol or when the symbols in the symbol display area have achieved a specific symbol combination, and
(C) an award is provided or a transition to a bonus game is executed after a predetermined effect with the specific image has been produced in a final stage of the primary effect.

5. The slot machine according to claim 4, wherein the controller is operable to
provide a first award when at least one of the symbols in the symbol display area has been the specific symbol or when the symbols in the symbol display area have brought the specific symbol combination, and
provide a second award when the predetermined effect has been produced in the final stage of the primary effect.

6. The slot machine according to claim 4, wherein the controller is operable to
display the specific image on the symbol display area in front of the last-stopped reel among the reels in synchronization with the stop timing of the last-stopped reel in case where the predetermined effect is to be produced in the final stage of the primary effect.

7. The slot machine according to claim 4, wherein the controller is operable to
make the specific image pass through the symbol display area of the last-stopped reel among the reels in case where the second award is not to be provided.

8. The slot machine according to claim 4, wherein the controller is operable to
make the specific image undisplayed on the symbol display area of the last-stopped reel among the reels in case where the second award is not to be provided.

9. A control method of a slot machine, comprising:
spinning, by a controller, plural reels each of which has symbols on its circumferential surface,
displaying, by the controller, an image on a display with the reels spinning, the display being provided in front of the reels and having an image display area including a symbol display area for displaying the symbols of the reels,
stopping, by the controller, the spinning reels, and
providing, by the controller, an award or executing a transition to a bonus game when the symbols of the reels displayed in the symbol display area and the image displayed in the image display area have achieved a specific combination.

10. The control method according to claim 9, further comprising:
while the reels are spinning, setting, by the controller, the symbol display area in the transmissive state and setting the image display area excluding the symbol display area in the image-displaying state, and
setting, by the controller, at least some area within the symbol display area in the image-displaying state in case where an image is to be displayed on the symbol display area of the reels.

11. The control method according to claim 9, further comprising:
stopping, by the controller, the spinning reels sequentially with time intervals, and
displaying, by the controller, a specific image on the symbol display area of the last-stopped reel among the reels in synchronization with the stop timing of the last-stopped reel.
